(19) United States
(12) Patent Application Publication
(10) Pub. No.: US 2013/0255450 A1
(43) Pub. Date: Oct. 3, 2013

(54) PLIERS

(71) Applicant: ROTHENBERGER, S.A., ABADIANO (Vizcaya) (ES)

(72) Inventor: Jose Ignacio PICAZA IBARRONDO, ABADIANO (Vizcaya) (ES)

(73) Assignee: ROTHENBERGER, S.A., ABADIANO (Vizcaya) (ES)

(21) Appl. No.: 13/791,371

(22) Filed: Mar. 8, 2013

(30) Foreign Application Priority Data
Apr. 2, 2012 (ES) P201230503

(51) Int. Cl. B25B 7/10

(52) U.S. Cl. CPC B25B 7/10
USPC 81/411

(57) ABSTRACT

Pliers, of the type comprised of two handles, one male and another female that are joined to each other by a joint bolt; and where the male handle defines a slotted window, of straight or curved configuration, the walls of which carry teeth or grooves along which the female handle can reach various working positions to vary the fastening capacity of the plier mouth.

It is characterized in that the joint bolt is mounted on the female handle with means to prevent its turning; it is mounted on the female handle without axial displacement; and has conformations, such as a reduced zone or milling, in correspondence with said slotted window.

It is also characterized in that it has means for the mutual locking/unlocking between handles without axial displacement of the bolt with respect to them.

The object of the invention refers to pliers of the type used for fastening, such as in plumbing.

In the current state of the art, pliers of this type are already known, comprised of two handles that are joined to each other by a joint bolt and where one of the handles can reach various working positions by linear displacement, straight or curved, in a slotted window of the other handle, to vary the fastening capacity of the plier mouth.

Known pliers include those that are comprised of two handles, one male and another female, which are joined to each other by joint bolt; where one of the handles defines a slotted window, straight or curved, in which the other handle can reach various working positions to vary the fastening capacity of the plier mouth.

There currently exist two possibilities for locating the straight or curved slotted window: with the window in the female handle (exterior) or with the window in the male handle (interior). In the case in which the slotted window is placed in the male handle, such as in files EP2054195; ES2277520 and ES2317725, the following problems appear with respect to the constitution, location and movement of the joint bolt:
the voluminosity, because the technical solution used required devices that are too large, with several components protruding, at least part of them, laterally with respect to the pliers, limiting their places of application;
the fragility and complexity of construction, because several of their components, generally small parts, are in view, exposed to impacts and dirt which deteriorate them, eventually rendering the pliers useless in a short period of time, especially if the action spring is in view;
great complexity in assembly, involving several components of very small size and in a very limited space to fit.

The pliers that are the object of the invention solve these problems. They are of the type comprised of two handles that are joined to each other by a joint bolt, where one of the handles defines a slotted window, straight or curved, in which the other handle can reach various working positions to vary the fastening capacity of the plier mouth and they are characterized in that they incorporate means to prevent the turning of the bolt-pin with respect to the handle that carries it and means to prevent the axial displacement of the bolt-pin with respect to both handles of the pliers.

The essence of the invention resides basically in using a single-component bolt, with a bolt configuration that prevents its turning and its axial movement with respect to its original location, resulting in very simplified pliers, and in the resolution of the aforementioned problems.

In the pliers, according to the invention:
the joint bolt is mounted fixed to one of the handles, with no turning or axial displacement with respect to it;
the joint bolt, mounted without turning on one of the handles, has milling facing the slotted window of the other handle, with respect to which it can turn or lock (in order for said milling to allow or not to allow it from reaching the different working positions), but not displace axially;
the joint bolt is mounted without protruding with respect to any side plane of the pliers, in order to not limit its possibilities of use or its operating functionality.

This technical solution is simple, as well as sturdy and reliable; moreover, it does not require any preliminary machining or assembly with adjustment, which simplifies the manufacturing and assembly work.

In particular, to mount the bolt with respect to the female handle that carries it without turning, there is an eccentric spline and an orifice-housing conjugated; placed, indistinctly, one on the bolt and the other on the female handle (or vice versa).

In particular, to prevent the axial displacement of the bolt with respect to the handles, there is a stud bolt attacking the eccentric spline of the bolt through the orifice-housing. Any other solution that is technically equivalent is included in the object of the invention, such as riveting.

Therefore, the content of this application constitutes a new invention which involves inventive activity and can be used for industrial application.

For a better understanding of the object of this invention, a preferential form of practical embodiment is shown in the drawings, subject to accessory changes which do not essentially alter it.

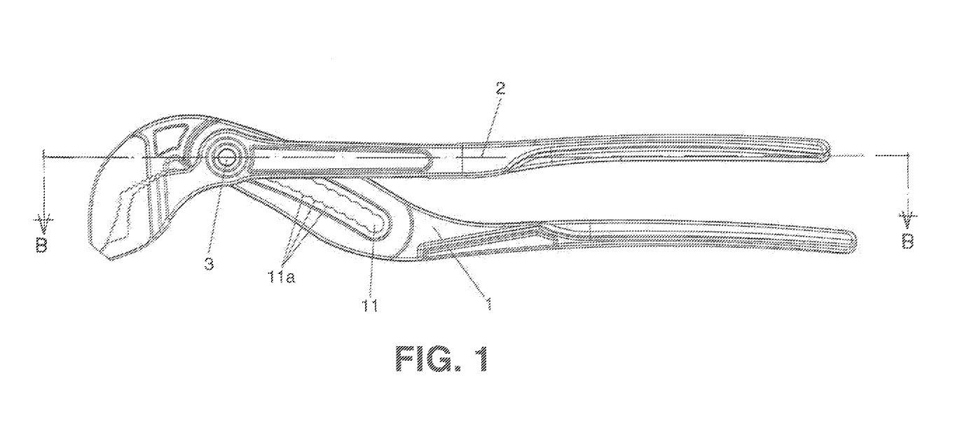

FIG. 1 represents a general elevated view of pliers according to the invention, for a non-limiting example of practical embodiment.

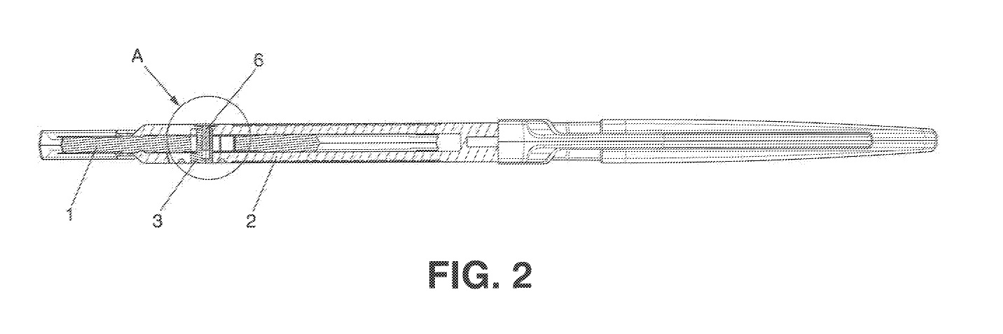

FIG. 2 represents a general section plan view, according to indication B:B of FIG. 1.

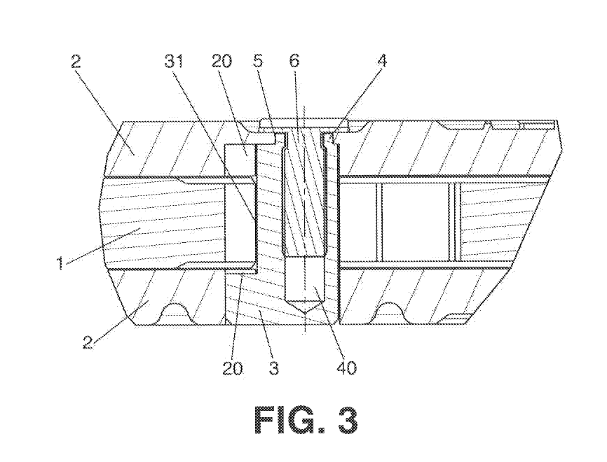

FIG. 3 represents a general enlarged view, according to detail A of FIG. 2.

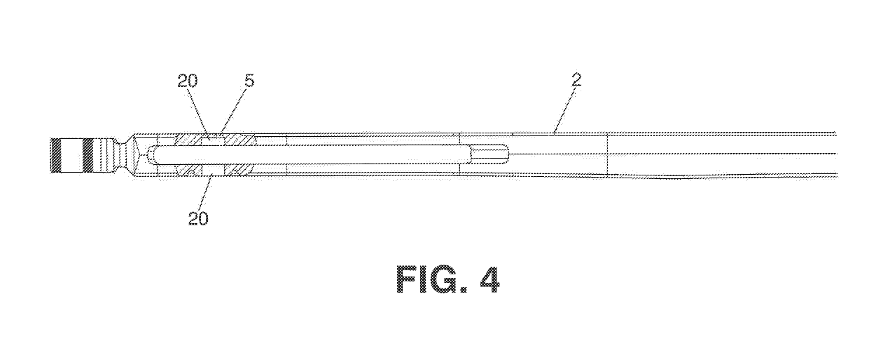

FIG. 4 represents a general section plan view similar to FIG. 2, but only of the female handle (2), to view its orifice-housings (20).

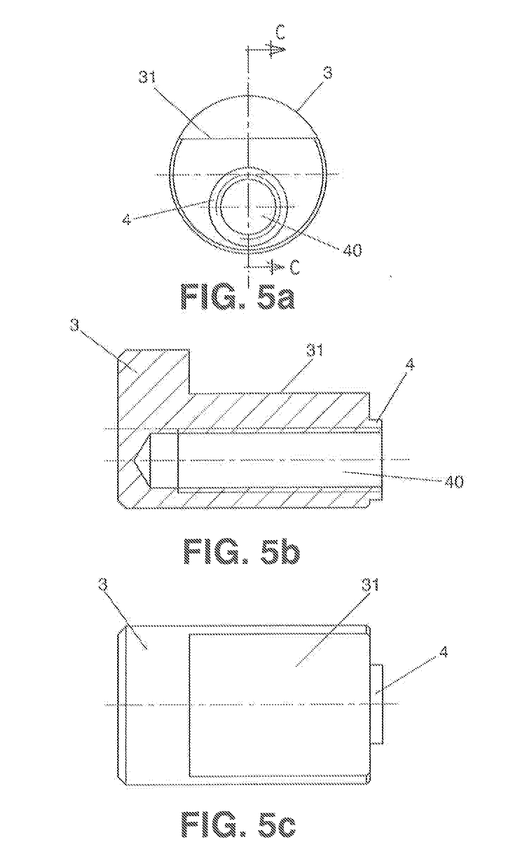

FIG. 5a represents a frontal view of the joint bolt (3).

FIG. 5b represents an elevated section, according to indication C:C of FIG. 5a.

FIG. 5c represents a plan view, corresponding to FIG. 5b.

The following is a description of an example of practical, non-limiting embodiment of this invention. Other ways of embodiment in which accessory changes which do not essentially alter it are introduced are in no way disregarded; on the contrary, this invention also encompasses all its variants.

The object of the invention refers to pliers of the type comprised of two handles: one male (1) and the other female (2) which are joined to each other by a joint bolt (3); and where the male handle (1) defines a slotted window (11), of straight or curved configuration, along which the female handle (2) can take various working positions to vary the fastening capacity of the mouth.

In a known way, male handle (1) defines the slotted window (11), of straight or curved configuration, with toothed or grooved walls (11a) and the female handle (2) defines two orifice-housings (20) facing each other on their walls, The joint bolt (3) is mounted on said orifices of the female handle (1). Said joint bolt (3) has conformations (31), such as a reduced zone or milling, which allow it to move or prevent it from moving in the slotted window (11) of the male handle (2) to reach the different working positions.

The slotted window (11 can be of straight or of curved configuration; therefore, the joint bolt (3) can have a straight or curved trajectory.

In conformity with the invention, the female handle (2) mounts in itself the joint bolt (3) with no possibility of turning or axial displacement. This joint bolt (3) is also mounted without axial displacement with respect to both handles (1), (2) of the pliers.

In conformity with the invention, and according to the embodiment represented:
the female handle (2) defines in continuity with the orifice-housing (20) of one of its wails, an eccentric orifice-housing (5);
the joint bolt (3) defines ample milling (31) and eccentric spline (4) in continuity with the body of the bolt itself (3).

To perform the mounting of the joint bolt (3) without turning with respect to the female handle (2), the spline (4) is housed in the orifice-housing (5) while the bolt (3) is housed in the orifice-seats (20) of the female handle (2).

To fix this position and prevent the joint bolt (3) from having lateral displacement with respect to the handles (1), (2), there is a stud bolt (6) in a threaded orifice (40) of the eccentric spline (4) so that the head of the stud bolt (6) attacks the perimeter of the orifice-housing (5) while the head of the bolt (3) attacks the perimeter of the orifice-seat (20) on the other side.

In this position, the milling (31 of the bolt (3) is always facing the slotted window (11), without lateral displacement with respect to the handle (1), but respect to which can rotate with the female handle (2) to vary the fastening capacity of the mouth. or lock in the different working positions.

The joint bolt (3) is mounted without protruding with respect to any side plane of the handles (1), (2) of the pliers, to not limit their possibilities of use or their operating functionality.

Any constructive solutions that are similar or equivalent to the one described, obtaining both the mounting of the joint bolt (3) without turning with respect to the female handle (2) and the mounting of the joint bolt (3) without axial displacement with respect to both handles (1) (2) of the pliers are included in the object of the invention, For example:
substituting the stud bolt (6) with a rivet of the eccentric spline (4); or
reversing the position: placing the eccentric spline (4) on the handle (2) and the orifice-housing (5) on the bolt (3);

With this simple structuring and simple mounting, the joint bolt (3) is mounted without turning or lateral displacement with respect to the female handle (2) and without lateral displacement with respect to either of the handles (1), (2) of the pliers. Moreover, the milling (31) of the joint bolt (3) is positioned on the slotted window (11) in such a manner that it allows the free displacement of the handle (2)/shaft (3) assembly in a position in which the milling (31) is parallel to a wall of the slotted window (11) and prevents the free displacement of the handle (2)/shaft (3) assembly in any other turned position, which corresponds with any working position of the pliers.

The materials, dimensions, proportions and, in general, those accessory or secondary details that do not essentially alter, change or modify the proposal may be variable.

The terms in which this report is written are a true reflection of the object described, and must be taken in their broadest sense and never in a limiting manner.

1. Pliers, of the type comprised of two handles, one male and another female, that are joined to each other by a joint bolt; where the male handle defines a slotted window, of straight or curved configuration, the walls of which carry teeth or grooves; along said slotted window the female handle can reach different working positions to vary the fastening capacity of the mouth, and where the joint bolt presents a reduced zone correspondence with the teeth or grooves of the slotted window; wherein the joint bolt is mounted on the female handle and have:
a) means to prevent the turning of the bolt with respect to the female handle, and
b) means to prevent the axial displacement of the bolt with respect to the female handle.

2. Pliers, according to claim 1, wherein the means to prevent the turning of the bolt with respect to the female handle are comprised of an eccentric spline and an orifice-housing, conjugated; placed, indistinctly, one on the bolt and the other on the female handle; thus preventing the turning of the bolt, with respect to the female handle that carries it.

3. Pliers, according to claim 2, wherein the means to prevent the axial displacement of the bolt with respect to the female handle comprised of a stud bolt in a threaded orifice of the eccentric spline to prevent the axial displacement of the bolt with respect to the female handle that carries it.
